(19) United States
(12) Patent Application Publication
(10) Pub. No.: US 2025/0062535 A1
(43) Pub. Date: Feb. 20, 2025

(54) ANTENNA STRUCTURE

(71) Applicant: HUAWEI TECHNOLOGIES CO., LTD., Shenzhen (CN)

(72) Inventors: Ignacio GONZALEZ, Munich (DE); Bruno BISCONTINI, Munich (DE); Fabrizio GENTILI, Munich (DE)

(21) Appl. No.: 18/934,588

(22) Filed: Nov. 1, 2024

Related U.S. Application Data
(63) Continuation of application No. PCT/EP2022/061775, filed on May 3, 2022.

(51) Int. Cl. H01Q 9/04; H01Q 3/36; H01Q 5/15; H01Q 5/28; H01Q 5/30; H01Q 19/10

(52) U.S. Cl. CPC H01Q 9/0414; H01Q 3/36; H01Q 5/15; H01Q 5/28; H01Q 5/30; H01Q 9/045; H01Q 19/10

(57) ABSTRACT

This disclosure provides implementations of an antenna structure. In one implementation, an antenna structure comprises a first stacked radiating structure comprising a plurality of radiators each at a respective stack level, a second stacked radiating structure comprising a plurality of radiators each stacked at a respective stack level, and a feeding network for supplying a signal to the radiators, the feeding network comprising a first branch configured to feed a first radiator of each of the first and second stacked radiating structures and a second branch configured to feed a second radiator of each of the first and second stacked radiating structures.

### CROSS-REFERENCE TO RELATED APPLICATIONS

This application is a continuation of International Application No. PCT/EP2022/061775, filed on May 3, 2022, the disclosure of which is hereby incorporated by reference in its entirety.

### FIELD OF THE INVENTION

This invention relates to antennas, in particular to antenna structures comprising multiple stacked radiating structures that are fed by a branched feeding network.

### BACKGROUND

An antenna is a transducer that converts radio frequency electric current to electromagnetic waves that are then radiated into space.

With the Long-Term Evolution (LTE) rollout almost complete, operators need to prepare their networks for the upcoming 5G. One of the key technologies to enable the new generation of mobile communications is multiple input multiple output (MIMO) below 6 GHz.

However, new deployments face traditional industry restrictions. The regulations in most countries, especially in Europe, are a real limiting factor when rolling out new services and infrastructures and most likely will be developed more slowly than the required technology.

To facilitate the site acquisition and fulfill the local regulations regarding site upgrades, the dimensions of new antennas should be comparable to legacy products. In addition, to be able to maintain the mechanical support structures in the sites, the wind load of new antennas should be equivalent to previous ones. These factors can lead to a very strict limitation in the width of the antenna.

It is well known that the directivity of an antenna is limited by its aperture, and therefore by the antenna width. This effect can become critical when several arrays are placed inside the same enclosure. As a result, antenna arrays placed in a small reflector usually exhibit a broad horizontal beam width.

In stacked antenna arrays, the radiator of one layer is connected with the radiators stacked on top. FIGS. 1(a) and 1(b) show perspective and vertical cross-sectional views respectively of an example of a stacked radiating structure 100 comprising upper and lower radiators, 101 and 102 respectively. The stacked radiators 101, 102 can have very different input impedances and the combination of them can result in a combined radiator, which can be very hard to match for a specific band width and phase difference.

As shown in FIG. 2, the combined radiating structure 100 is traditionally fed using a feeding circuit which feeds both radiators 101, 102 of the stacked radiating structure 100 simultaneously. The antenna reflector for the stacked radiating structure is shown at 103. The feeding circuit 104 can comprise a phase shifter 105 which produces a phase shift between the respective signals feeding each of the radiators 101 and 102.

FIG. 3 shows a schematic illustration of the feeding of an antenna array 300 comprising multiple stacked radiating structures of the type 100. Traditionally, the feeding in an array is carried out by feeding each stacked structure and connecting the feeding lines for the resulting stacked radiating structures at an antenna port 106.

Further radiators can also be stacked in the z-axis. For example, WO 2022/028669 A1 discloses antenna arrays, examples of which are shown in FIG. 4, which stack multiple radiators in the z-direction in order to increase the number of clusters 401 (sub-arrays) without increasing the aperture area. A greater number of clusters can provide a higher exploitation of the potential degrees of freedom of the aperture, thus enhancing system performance.

It is desirable to develop an antenna structure that can allow greater freedom in the design of the feeding network, as well as improved efficiency.

### SUMMARY OF THE INVENTION

According to a first aspect there is provided an antenna structure comprising: a first stacked radiating structure comprising a plurality of radiators each at a respective stack level; a second stacked radiating structure comprising a plurality of radiators each stacked at a respective stack level; a branched feeding network for supplying a signal to the radiators, the feeding network comprising a first branch configured to feed one radiator of each of the first and second stacked radiating structures and a second branch configured to feed another radiator of each of the first and second stacked radiating structures.

Feeding an antenna structure by stack level (or combinations of stack levels) rather than by feeding each complete stacked structure has been shown to provide an efficiency increase of approximately 10%. A further benefit of applying this technique is an additional degree of freedom in the design of the feeding network, which depending on the impedances of the radiating structures composing the array can lead to better decoupling, larger bandwidth and reduced cost.

The first branch of the feeding network may be configured to be feed only the one (i.e. only one) radiator of each of the first and second stacked radiating structures. The second branch of the feeding network may be configured to feed only the another (i.e. only one) radiator of each of the first and second stacked radiating structures. This may allow for greater freedom in the configuration of the feeding network and may result in improved efficiency.

The one radiator of the first radiating structure may be disposed at the same stack level as the one radiator of the second stacked radiating structure. The one radiator of the first radiating structure may be disposed at a different stack level to the one radiator of the second stacked radiating structure. This may allow for further flexibility in the configuration of the feeding network.

Radiators at each respective stack level of the first and second stacked radiating structures may form a layer of radiators disposed in a respective plane. This may be a spatially efficient solution.

The antenna structure may further comprise a planar reflector for reflecting electromagnetic radiation emitted by the plurality of radiators of the first and second stacked radiating structures. Each respective plane in which each layer of radiators is disposed may be parallel to but offset from the planar reflector. Arranging the radiators in parallel layers may further improve spatial efficiency.

The plurality of radiators of the first and second stacked radiating structures may have a respective common grounding structure. Grounding the radiators of each structure via a common grounding element may improve spatial efficiency in the antenna.

Each of the plurality of radiators of the first and second stacked radiating structures may have an independent feeding point. This may allow each radiator to be fed independently, for example with a phase shift of its respective signal relative to another radiator.

Each branch of the feeding network may comprise one or more power dividers or phase shifters. This may allow each branch to feed multiple radiators, with an amplitude and/or phase shift between the respective signals supplied to respective radiators if desired.

Each branch of the feeding network may be combined with the other branches of the feeding network at an antenna port. This may allow the radiators of the antenna structure to be fed from a common antenna port.

Each of the first and second stacked radiating structures may comprise a first radiator configured to emit electromagnetic radiation having a first operational frequency band and a second radiator configured to emit electromagnetic radiation having a second operational frequency band. The first and second operational frequency bands may be different. The first and second operational frequency bands may at least partially overlap. The first and second operational frequency bands may fully overlap. In some embodiments, the second operational frequency band may fully overlap the first operational frequency band, or vice versa. Such a structure may be conveniently configured to comprise radiators that can emit electromagnetic radiation having frequencies of one or more of 700M, 800M, 900M, 1.8G, 2.1G, 2.6G and 3.5 GHz all together in a structure such as a base band station antenna in order to support 5G. The solution may therefore be implemented in applications requiring the emission of different signals within different frequency bands by multiple radiators.

The branched feeding network may comprise multiple branches. Each branch of the feeding network may comprise a proximal end and multiple distal ends, each distal end of a branch being connected to a respective radiator for supplying a respective signal thereto. This may allow each branch to feed multiple radiators across different stacked radiating structures in the antenna structure.

The antenna structure may comprise at least one further stacked radiating structure comprising a plurality of radiators each stacked at a respective stack level. This may allow for use of the approach in a large antenna array.

The feeding network may further comprise at least one further branch. Each further branch may be configured to feed a respective further radiator of each of the first and second stacked radiating structures. This may allow for use of the approach in an antenna array comprising three or more stacked radiators in each radiating structure.

At least one branch of the feeding network may comprise a power splitter. The power splitter may be configured to control the amplitude difference between different radiators. The power splitter may be a Wilkinson power divider or a hybrid power divider. Other types of power splitters or dividers may be used. For example, a T-junction with any particular chosen phase and amplitude distribution. This may allow each branch of the feeding network to supply a signal to multiple radiators.

The plurality of radiators of the first and second stacked radiating structures may be configured to be fed with a phase difference between their respective signals.

At least one of the plurality of radiators of the first and second stacked radiating structures may comprise two dipoles. The polarization of electromagnetic radiation emitted by the two dipoles may be orthogonal. For example, one dipole may emit vertically polarised radiation and the other horizontally polarised radiation. The polarization of electromagnetic radiation emitted by the two dipoles may be +/−45 degrees.

At least some of the radiators may be planar. This may be a convenient spatial configuration that allows the radiators to be efficiently stacked.

The first stacked radiating structure may be adjacent to the second stacked radiating structure. This may be a spatially efficient configuration for arranging the radiating structures.

At least one of the first and second stacked radiating structures may be a base element for a broadside array. The antenna structure may be part of an end-fire array. In broadside array, the direction of the maximum radiation is perpendicular to the axis of the array, while in an end-fire array, the direction of the maximum radiation is along the axis of array. The present approach is therefore suitable for use in various antenna configurations.

The antenna structure may be a multiple input multiple output (MIMO) antenna. Therefore, the antenna structure may be used in multiuser cellular communication systems based on massive-MIMO.

According to a second aspect there is provided an antenna array comprising at least two antennas having the antenna structure described above. This may allow the antenna structure to be combined with other such structures, for example in rows or columns.

### BRIEF DESCRIPTION OF THE FIGURES

The present invention will now be described by way of example with reference to the accompanying drawings. In the drawings:

FIGS. 1(a) and 1(b) show perspective and vertical cross-sectional views of an example of a stacked radiating structure;

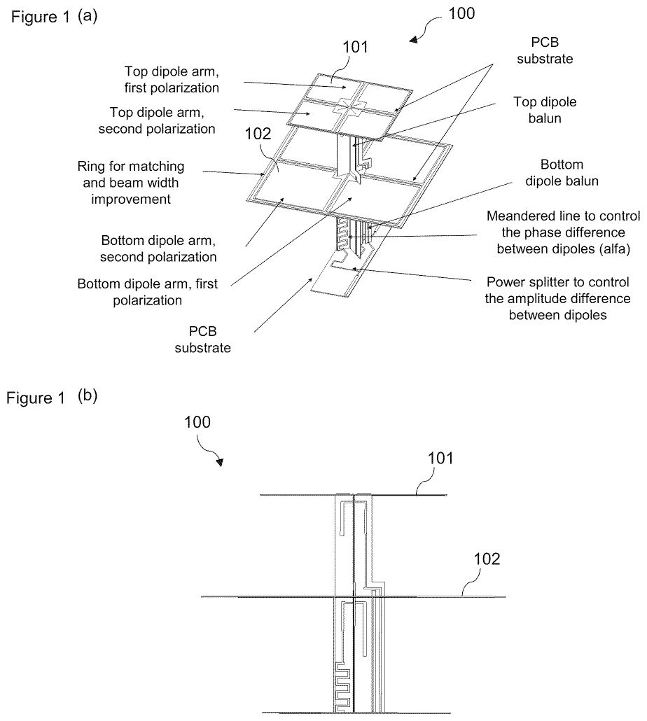

FIG. 2 shows an example of a known solution for feeding a stacked radiating structure;

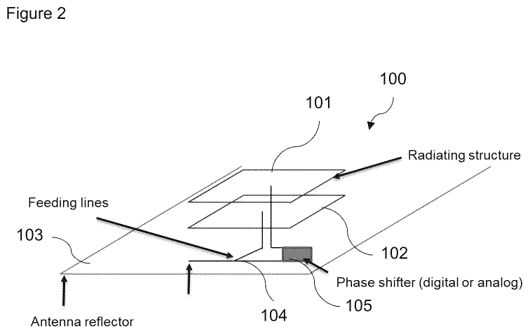

FIG. 3 schematically illustrates a known solution for feeding an array of stacked radiating structures;

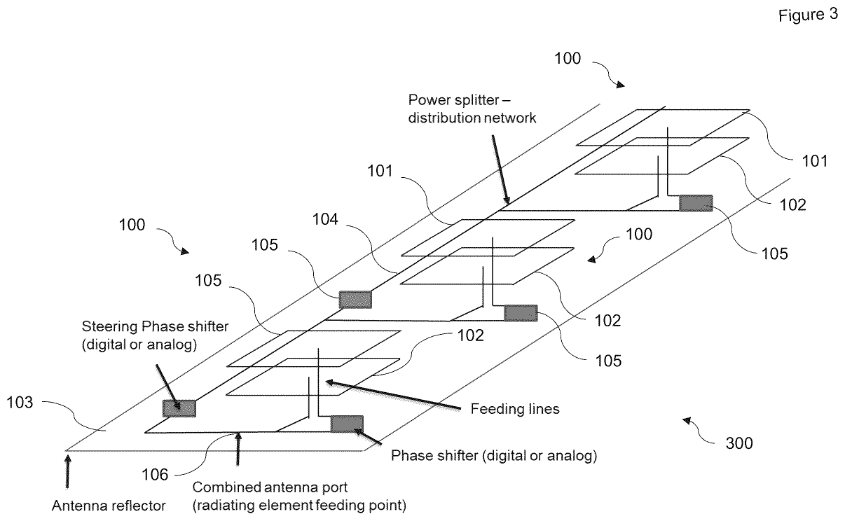

FIG. 4 schematically illustrates a known radiating structure which stacks multiple radiators in the z-direction in order to increase the number of clusters without increasing the aperture area;

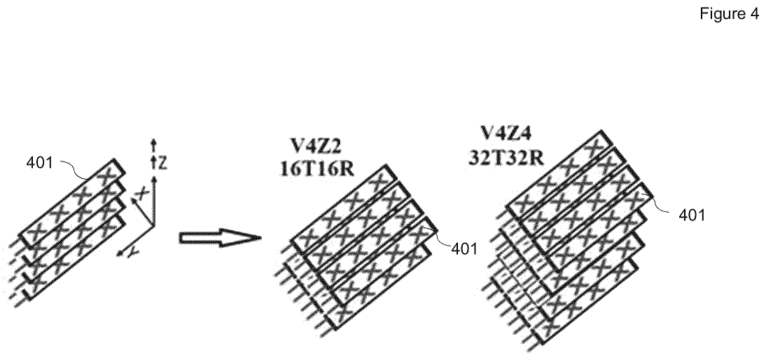

FIG. 5 is a schematic illustration to aid understanding of the terms and structures described herein;

FIG. 6 shows an example of an antenna array;

FIG. 7 shows another example of an antenna array;

FIG. 8 shows a further example of an antenna array; and

FIG. 9 shows an example of a massive-MIMO antenna.

### DETAILED DESCRIPTION OF THE INVENTION

In embodiments of the present invention, radiators of an antenna array comprising multiple stacked radiating structures are fed by layer, or in combinations of radiators across different layers, rather than by feeding the radiators of each stacked radiating structure together.

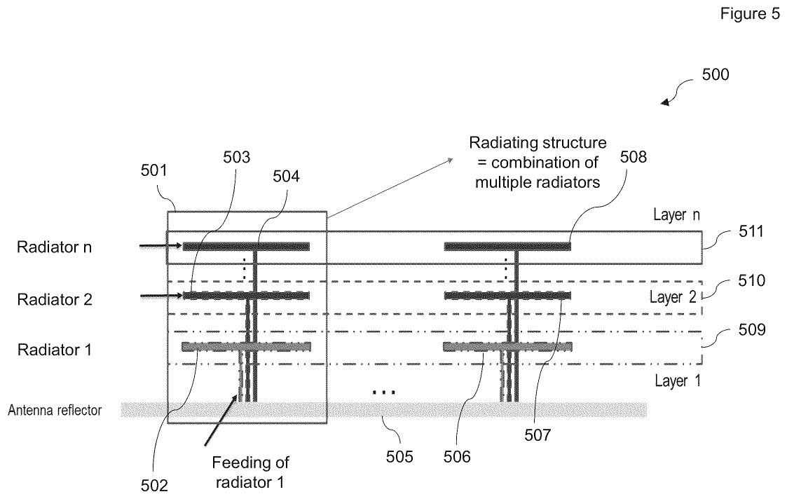

FIG. 5 shows a schematic diagram illustrating some of the terms and definitions used herein. An antenna array 500 comprises multiple stacked radiating structures. The box at 501 shows one stacked radiating structure. The stacked radiating structure comprises multiple radiators 502, 503, 504. Generally, the stacked radiating structure 501 comprises n radiators. n is greater than or equal to 2. In the example shown in FIG. 5, radiator 1, 502, of the structure 501 is located closest to antenna reflector 505 in a first direction. In the preferred implementation, the first direction is perpendicular to a plane of the antenna reflector 505. The antenna reflector 505 acts as a global reflector to reflect radiation emitted by the radiators in the array. Radiator 2, 503, is spaced from radiator 1, 502, in the first direction. Radiator n, 504, is located furthest from antenna reflector 505 in the first direction. The radiators of each of the stacked radiating structures that are in the same layer are preferably at the same distance from the antenna reflector in the first direction. The radiators of each radiating structure are each spaced from other radiators in the same radiating structure in the first direction.

The radiators 506, 507 and 508 are the 1^{st}, 2^{nd} and n^{th} radiators of a second radiating structure adjacent to the first radiating structure.

In this example, the radiators form layers. Layer 1, indicated at 509, comprises radiators 502 and 506. Layer 2, indicated at 510, comprises radiators 503 and 507. Layer n, indicated at 511, comprises radiators 504 and 508. In this example, the layers overlap. In other examples, the layers may partially overlap.

Each radiator of each layer may have a different impedance, and given an arbitrary steering of the antenna array, the combination of the radiators will produce a different combined impedance, potentially leading to different band width and isolation results.

In embodiments of the present invention, the stacked radiating structures resulting from the combination of the radiators are connected with a feeding network.

Each of the plurality of radiators of the stacked radiating structures preferably has an independent feeding point, which can allow different radiators in each stacked structure to be fed by different branches of the feeding network and with a phase shift and/or amplitude difference between their respective signals, if desired.

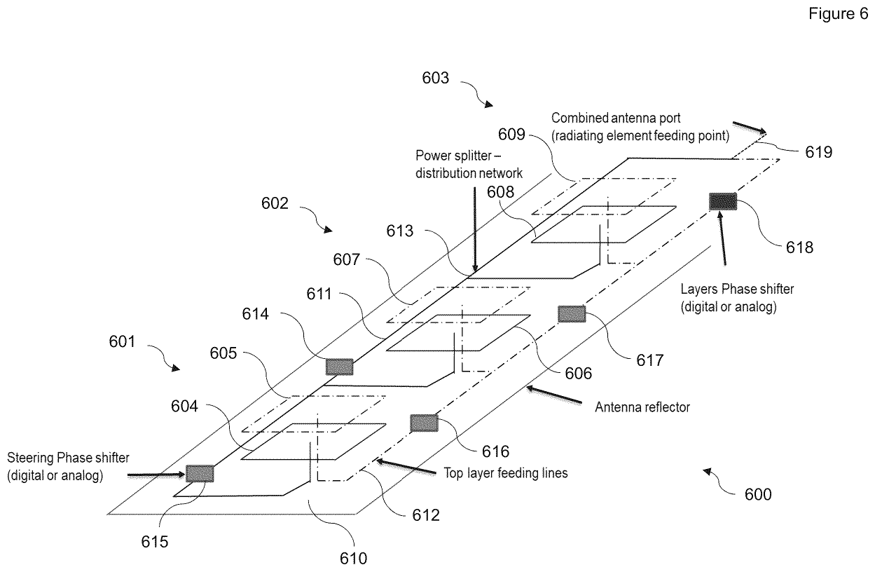

FIG. 6 shows a first embodiment of an antenna array 600 comprising multiple stacked radiating structures 601, 602, 603. Each radiating structure in the array is adjacent to (i.e. located beside) one or more other radiating structures in the array. In this example, a first radiating structure 601 is located adjacent to a second radiating structure 602. The second radiating structure 602 is located adjacent to a third radiating structure 603. The second radiating structure 602 is located between the first and third radiating structures 601 and 603 respectively.

In this example, each stacked radiating structure 601, 602, 603 comprises two radiators: a first radiator and a second radiator spaced from the first radiator in a first direction. The first and second radiators of structure 601 are shown at 604 and 605 respectively. The first and second radiators of structure 602 are shown at 606 and 607 respectively. The first and second radiators of structure 603 are shown at 608 and 609 respectively.

Both of the first and second radiators of each structure 601, 602, 603 are spaced from an antenna reflector 610 in the first direction. In this example, the antenna reflector 610 is planar and the first direction is perpendicular to the plane of the antenna reflector. The antenna reflector 610 is configured to reflect electromagnetic radiation emitted by the plurality of radiators of each of the stacked radiating structures 601, 602, 603.

In this example, each radiator of the radiating structures 601, 602, 603 is at a respective stack level. Radiators 604, 606 and 608 are at stack level one and radiators 605, 607 and 609 are at stack level two. In other embodiments, there may be n such stack levels.

In this example, each of the radiators 604-609 is planar. For example, the planar radiators may be dipole antenna elements comprising two dipoles. The polarization of electromagnetic radiation emitted by the two dipoles may be orthogonal. The polarization of electromagnetic radiation emitted by the two dipoles may be +/−45 degrees.

Radiators at each respective stack level form a layer of radiators disposed in a respective plane. Each respective plane of radiators forms a layer is parallel to but offset from the planar reflector 610. Radiators 604, 606 and 608 form a first layer of radiators and radiators 605, 607 and 609 form a second layer of radiators. In other embodiments, there may be n such layers of radiators.

In this example, one radiator of each of the radiating structures 601, 602, 603 is configured to emit electromagnetic radiation having a first operational frequency band and the other radiator of each of the radiating structures 601, 602, 603 is configured to emit electromagnetic radiation having a second operational frequency band. The first and second operational frequency bands may be different. Preferably, the second operational frequency band at least partially overlaps the first operational frequency band. In some embodiments, the second operational frequency band may fully overlap the first operational frequency band, or vice versa. In the case of partially overlapping or fully overlapping frequency bands, the upper radiator in the stack may exhibit enough transparency to the first radiator in order not to interfere with its performance due to shadowing. The operational frequency bands of radiators in the same stack level (or layer) may be the same or may be different. For example, the six radiators in array 600 may each emit electromagnetic radiation having a different operational frequency band to the other radiators.

Such a structure may be conveniently configured to radiate at frequency bands of 700M, 800M, 900M, 1.8G, 2.1G, 2.6G and 3.5 GHz in a structure such as a base band station antenna in order to support 5G.

For supplying a signal to the radiators, the radiators of the radiating structures are fed by a branched feeding network. The feeding network may comprise one or more cables, conductors or waveguides. The feeding network comprises multiple branches. Each branch is configured to feed one or more radiators of the antenna structure.

In the preferred implementation, multiple branches are each configured to feed multiple radiators of the antenna structure.

Each branch connects its respective radiator(s) to an antenna port, from which the signal is provided to the radiator(s). Specifically, each branch connects a feeding point of each of its respective radiator(s) to an antenna port. Each radiator in the antenna structure may have an independent feeding point.

Each branch may comprise multiple arms, with each arm of a respective branch being connected to a feeding point of the respective radiators which the respective branch feeds. Each branch may also comprise one or more intermediate limbs which connect multiple arms of the respective branch to the antenna port. Each branch may comprise one or more junctions at which one or more arms and/or one or more intermediate limbs of the branch meet. Preferably, the arms and/or intermediate limbs of a branch meet at one terminal junction, from which a single feeding line of the branch connects to the antenna port. Multiple branches of the feeding network may have the above features.

In FIG. 6, the branched feeding network comprises two branches 611 and 612. Branch 611 is configured to feed a signal to radiators 604, 606 and 608. Branch 612 is configured to feed a signal to radiators 605, 607 and 609. The radiators are directly fed from the same source. The branches meet (i.e. are connected to each other) at combined antenna port 619.

Branch 611 comprises a feeding line from antenna port 619 which splits at a junction into an arm which is configured to feed radiator 608 and an intermediate limb which is configured to feed radiators 606 and 604. The intermediate limb splits at a further junction into two arms configured to feed radiators 606 and 604 respectively. Branch 612 has a similar structure: a feeding line from antenna port 619 splits at a junction into an arm which is configured to feed radiator 609 and an intermediate limb which is configured to feed radiators 607 and 607. The intermediate limb splits at a further junction into two arms configured to feed radiators 607 and 605 respectively.

Therefore, each branch of the feeding network comprises a proximal end (the end closest to the antenna port in operation) and multiple distal ends. Each distal end of a branch is connected to a radiator for supplying a signal thereto.

In the example shown in FIG. 6, only one radiator of each of the stacked radiating structures 601, 602, 603 is fed from the first branch of the feeding network 611 and only one radiator of each of the stacked radiating structures 601, 602, 603 is fed from the second branch 612 of the feeding network. The first branch 611 is configured to feed the lower radiators 604, 606, 608 (closest to the reflector 610 in the first direction) of each of the stacked radiating structures. The second branch 612 is configured to feed the upper radiators 605, 607, 609 (furthest from the reflector 610 in the first direction) of each of the stacked radiating structures. Therefore, in this example, the radiators fed by the first branch 611 are disposed at the same stack level and the radiators fed by the second branch 612 are disposed at the same stack level.

It is also possible for a branch of the feeding network to feed more than one radiator in a stacked radiating element. However, preferably, the branch does not feed all of the radiators in a stacked radiating structure.

In the preferred implementation, the radiators of each radiating structure 601, 602, 603 have a respective common grounding structure.

As mentioned above, the radiators are directly fed from the same source. However, in some embodiments, the plurality of radiators of each stacked radiating structure 601, 602, 603 may be configured to be fed with a phase difference between their respective signals. For example, radiators 604 and 605 of stacked radiating structure 601 may be fed with a phase difference between their respective signals. The same may be true for each of the radiating structures 602 and 603. The difference of phase may be controlled by means of a phase shifter (digital or analogue) or may be fixed. As shown in FIG. 6, each branch of the feeding network may further comprise one or more phase shifters 615-618.

A phase shifter can be located after a junction between two arms, or a junction between an arm and an intermediate limb, in order to shift the phase of the signal being supplier to a particular radiator. In FIG. 6, phase shifter 618 is configured to shift the phase of the signal supplied by branch 612 relative to branch 611. Phase shifters 617 and 616 are configured to shift the phase of the signal supplied to radiators 607 and 605 respectively relative to the signal supplier to radiator 609. In branch 611, phase shifters 614 and 615 are configured to shift the phase of the signal supplied to radiators 606 and 604 respectively relative to the signal supplier to radiator 608.

At least one branch of the feeding network may comprise a power splitter or divider 613. The power splitter may be a Wilkinson power divider, a hybrid power divider or another type of power divider. A power splitter may be located at the junction between one or more arms or intermediate limbs of a respective branch of the feeding network. The power splitter is configured to control the amplitude difference of the signal supplied to different radiators. For example, power splitter 613 is configured to control the amplitude of the signal supplied to radiator 608 relative to the other radiators supplied by branch 611.

The difference of phase and/or amplitude can be chosen arbitrarily among the radiators (parallel feed). In some embodiments, the phase and/or amplitude difference may be specifically selected to improve the antenna directivity.

Therefore, in this example, the radiators at the same stack level (for example, in the same layer) are connected together by a branch of a feeding network.

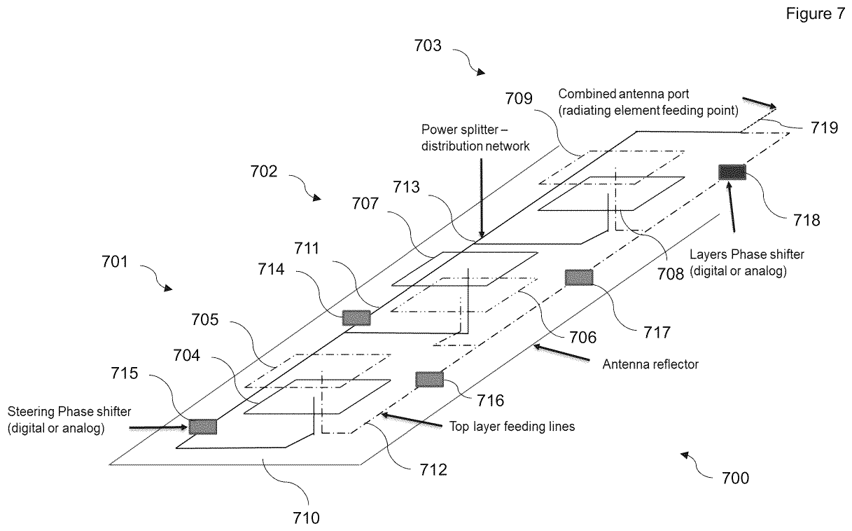

In other examples, such as that shown in FIG. 7, the one radiator of the first radiating structure may be disposed at a different stack level to the one radiator of the second stacked radiating structure fed by the same branch.

FIG. 7 shows an alternative implementation of an array 700 where each branch feeds alternating upper and lower radiators in the stacked radiating structures 701, 702, 703. This embodiment is an example of a dual layer array (layer one and layer two of radiators), where the radiators are combined by selecting different radiators from different layers.

Antenna array 700 comprises stacked radiating structures 701, 702, 703. Each radiating structure in the array is adjacent to (i.e. located beside) one or more other radiating structures in the array. In this example, a first radiating structure 701 is located adjacent to a second radiating structure 702. The second radiating structure 702 is located adjacent to a third radiating structure 703. The second radiating structure 702 is located between the first and third radiating structures 701 and 703 respectively.

Each stacked radiating structure 701, 702, 703 comprises two radiators: a first radiator and a second radiator spaced from the first radiator in a first direction. The first and second radiators of structure 701 are shown at 704 and 705 respectively. The first and second radiators of structure 702 are shown at 706 and 707 respectively. The first and second radiators of structure 703 are shown at 708 and 709 respectively.

Both of the first and second radiators of each structure 701, 702, 703 are spaced from an antenna reflector 710 in the first direction.

Each radiator of the radiating structures 701, 702, 703 is at a respective stack level. Radiators 704, 706 and 708 are at stack level one and radiators 705, 707 and 709 are at stack level two. In other embodiments, there may be n such stack levels.

As in the previous example, each of the radiators 704-709 is planar.

Radiators at each respective stack level form a layer of radiators disposed in a respective plane. Each respective plane of radiators forms a layer is parallel to but offset from the planar reflector 710. Radiators 704, 706 and 708 form a first layer of radiators and radiators 705, 707 and 709 form a second layer of radiators. In other embodiments, there may be n such layers of radiators.

Each of the radiators may emit electromagnetic radiation in a particular operational frequency band, as described above with respect to the embodiment of FIG. 6. In this example, one radiator of each of the radiating structures 701, 702, 703 is configured to emit electromagnetic radiation having a first operational frequency band and the other radiator of each of the radiating structures 701, 702, 703 is configured to emit electromagnetic radiation having a second operational frequency band. The first and second operational frequency bands may be different. Preferably, the second operational frequency band at least partially overlaps the first operational frequency band. In some embodiments, the second operational frequency band may fully overlap the first operational frequency band, or vice versa. The operational frequency bands of radiators in the same stack level (or layer) may be the same or may be different.

In this example, each branch of the feeding network is configured to feed one radiator of each of the radiating structures.

In FIG. 7, the branched feeding network comprises two branches 711 and 712. Branch 711 is configured to feed a signal to radiators 704, 707 and 708. Branch 712 is configured to feed a signal to radiators 705, 706 and 709. The radiators are directly fed from the same source. The branches meet (i.e. are connected to each other) at combined antenna port 719. The branches may have arms, intermediate limbs and junctions, as described above with reference to the embodiment of FIG. 6.

Branch 711 comprises a feeding line from antenna port 719 which splits at a junction into an arm which is configured to feed radiator 708 and an intermediate limb which is configured to feed radiators 707 and 704. The intermediate limb splits at a further junction into two arms configured to feed radiators 707 and 704 respectively. Branch 712 has a similar structure: a feeding line from antenna port 719 splits at a junction into an arm which is configured to feed radiator 709 and an intermediate limb which is configured to feed radiators 706 and 705. The intermediate limb splits at a further junction into two arms configured to feed radiators 706 and 705 respectively.

Therefore, each branch of the feeding network comprises a proximal end and multiple distal ends. Each distal end of a branch is connected to a radiator for supplying a signal thereto.

In this example, only one radiator of each of the stacked radiating structures 701, 702, 703 is fed from the first branch of the feeding network 711 and only one radiator of each of the stacked radiating structures 701, 702, 703 is fed from the second branch 712 of the feeding network. The first branch 711 is configured to feed alternating lower and upper radiators 704, 707, 708 of each of the stacked radiating structures 701, 702, 703. The second branch 712 is configured to feed alternating upper and lower radiators 705, 706, 709 of each of the stacked radiating structures 701, 702, 703. Therefore, in this example, the radiators fed by each branch are disposed at alternating stack levels (i.e. each branch does not feed all of the radiators in the same stack level or layer).

It is also possible for a branch of the feeding network to feed more than one radiator in a stacked radiating element. However, preferably, the branch does not feed all of the radiators in a stacked radiating structure.

In the preferred implementation, the radiators of each radiating structure 701, 702, 703 have a respective common grounding structure.

The feeding network may include power dividers and phase shifters, which may operate as previously described with respect to the example of FIG. 6.

In FIG. 7, phase shifter 718 is configured to shift the phase of the signal supplied by branch 712 relative to branch 711. Phase shifters 717 and 716 are configured to shift the phase of the signal supplied to radiators 706 and 705 respectively relative to the signal supplier to radiator 709. In branch 711, phase shifters 714 and 715 are configured to shift the phase of the signal supplied to radiators 707 and 704 respectively relative to the signal supplier to radiator 708.

The approach can be extended to #n layers and #m combinations of radiators, where n and m are greater than 1.

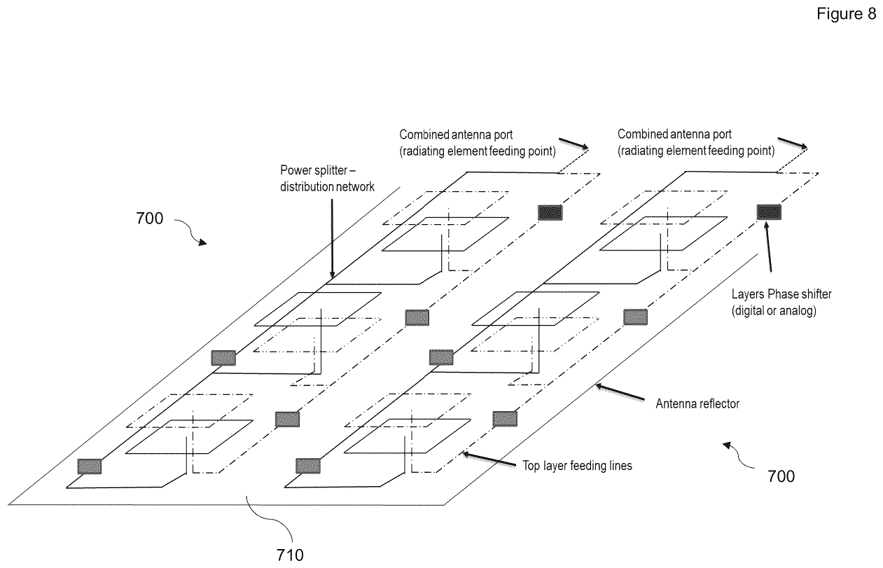

FIG. 8 shows two columns of stacked radiating structures. Each column has the same structure as the array 700 described with reference to FIG. 7. In this example, the antenna reflector 710 is common to both columns. This design may be used to integrate massive multiple input multiple output (mMIMO) antennas with different passive antenna arrays.

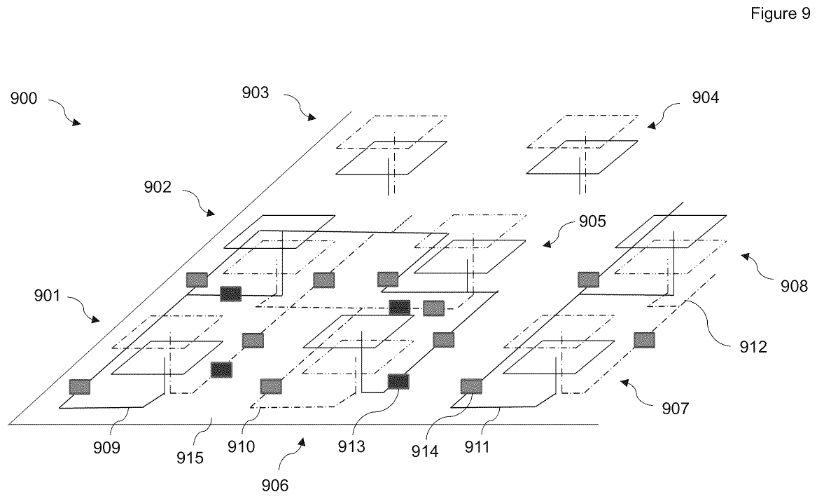

FIG. 9 shows an example of a mMIMO antenna 900 comprising multiple stacked radiating structures 901-908. The structures 901-908 share a global antenna reflector 915. Radiators are connected via branches 909, 910, 911, 912 of a feeding network to radiators in different layers or the same layer to profit from the additional degree of freedom. In this example, each of the branches do not feed more than one radiator in a particular stacked radiating structure. As described in the previous examples, the feeding network can also include various phase shifters, such as those indicated at 913 and 914, and power splitters.

In the examples shown in FIGS. 6 to 9, the antenna structure comprises two layers of radiators in each radiating structure. However, the antenna structure may comprise further layers of radiators. The feeding network may further comprise one or more additional branches. Each branch may be configured to feed a respective further radiator in the one or more further layers. The upper layers should preferably exhibit enough transparency to the lower layers in order not to interfere with their performance due to shadowing. This can be achieved using a variety of known methods.

Thus, the stacked radiators of the antenna array are fed in layers (or a combination of layers), rather than by feeding each stack of radiators using one branch of a feeding network. A radiator in one layer is connected through a feeding network with the radiators of the same layer or with radiators of different layers, but not with the radiators with which it is stacked.

This method of feeding the radiators has been simulated and has proved to be beneficial (in comparison with other traditional cluster distributions) in certain scenarios. Feeding by layer rather than by stacked structure has been shown to provide an efficiency increase of approximately 10%.

A further benefit of applying this technique is an additional degree of freedom in the design of the feeding network, which depending on the impedances of the radiating structures composing the array can lead to better decoupling, larger bandwidth and reduced cost.

The antenna structure may be an end-fire array of radiators. At least one of the stacked radiating structures may be used as a base element for a broadside array (for example, in a base station antenna array). The antenna structure may be a multiple input multiple output antenna.

This antenna configuration can be used in a range of devices, such as mobile phones, base stations, radars or antennas mounted on airplanes. Specifically, but not exclusively, this concept has application in multiuser cellular communication systems based on massive-MIMO.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. An antenna structure comprising:
a first stacked radiating structure comprising a plurality of radiators each at a respective stack level;
a second stacked radiating structure comprising a plurality of radiators each stacked at a respective stack level; and
a feeding network for supplying a signal to the radiators, the feeding network comprising a first branch configured to feed a first radiator of each of the first and second stacked radiating structures and a second branch configured to feed a second radiator of each of the first and second stacked radiating structures.

2. The antenna structure according to claim 1, wherein the first branch of the feeding network is configured to feed only the first radiator of each of the first and second stacked radiating structures.

3. The antenna structure according to claim 1, wherein the second branch of the feeding network is configured to feed only the second radiator of each of the first and second stacked radiating structures.

4. The antenna structure according to claim 1, wherein the first radiator of the first radiating structure is disposed at the same stack level as the first radiator of the second stacked radiating structure.

5. The antenna structure according to claim 1, wherein the first radiator of the first radiating structure is disposed at a different stack level to the first radiator of the second stacked radiating structure.

6. The antenna structure according to claim 1, wherein radiators at each respective stack level of the first and second stacked radiating structures form a layer of radiators disposed in a respective plane.

7. The antenna structure according to claim 6, wherein the antenna structure further comprises a planar reflector for reflecting electromagnetic radiation emitted by the plurality of radiators of the first and second stacked radiating structures, wherein each respective plane is parallel to but offset from the planar reflector.

8. The antenna structure according to claim 1, wherein the plurality of radiators of the first and second stacked radiating structures have a common grounding structure.

9. The antenna structure according to claim 1, wherein each of the plurality of radiators of the first and second stacked radiating structures has an independent feeding point.

10. The antenna structure according to claim 1, wherein each branch of the feeding network comprises one or more phase shifters.

11. The antenna structure according to claim 1, wherein each branch of the feeding network is combined with the other branches of the feeding network at an antenna port.

12. The antenna structure according to claim 1, wherein each of the first and second stacked radiating structures comprises a first radiator configured to emit electromagnetic radiation having a first operational frequency band and a second radiator configured to emit electromagnetic radiation having a second operational frequency band.

13. The antenna structure according to claim 12, wherein the first and second operational frequency bands at least partially overlap.

14. The antenna structure according to claim 1, wherein the antenna structure comprises at least one additional stacked radiating structure comprising a plurality of radiators each stacked at a respective stack level.

15. The antenna structure according to claim 1, wherein the feeding network further comprises at least one additional branch, each of the at least one additional branch being configured to feed a respective additional radiator of each of the first and second stacked radiating structures.

16. The antenna structure according to claim 1, wherein at least one branch of the feeding network comprises a power splitter, wherein the power splitter is a Wilkinson power divider or a hybrid power divider.

17. The antenna structure according to claim 1, wherein the plurality of radiators of the first and second stacked radiating structures are configured to be fed with a phase difference between their respective signals.

18. The antenna structure according to claim 1, wherein at least one of the plurality of radiators of the first and second stacked radiating structures comprises two dipoles and wherein the polarization of electromagnetic radiation emitted by the two dipoles is orthogonal.

19. The antenna structure according to claim 1, wherein at least a portion of the radiators are planar.

20. The antenna structure according to claim 1, wherein the first stacked radiating structure is adjacent to the second stacked radiating structure.
